(19) United States
(12) Patent Application Publication
(10) Pub. No.: US 2017/0316462 A1
(43) Pub. Date: Nov. 2, 2017

(54) Conditional Signaling of Web Page Events Relating to Consumer Attention

(71) Applicant: Oracle America, Inc., Redwood Shores, CA (US)

(72) Inventors: Theodore V. McConnell, Cincinnati, OH (US); Christopher Tsoufakis, Salt Lake City, UT (US); Michael Garrett Seiler, Scarsdale, NY (US); Nikki Kyle Gomez, Brooklyn, NY (US); Jonah Goodhart, Ithaca, NY (US); Aniq Rahman, New York, NY (US)

(73) Assignee: Oracle America, Inc., Redwood Shores, CA (US)

(21) Appl. No.: 14/032,019

(22) Filed: Sep. 19, 2013

Related U.S. Application Data
(60) Provisional application No. 61/703,223, filed on Sep. 19, 2012.

(51) Int. Cl. G06Q 30/02

(52) U.S. Cl. CPC G06Q 30/0269

(57) ABSTRACT

A system and methods for providing data to interested entities (e.g., publisher or advertiser) on consumer behavior when viewing advertising displayed on web pages is described. In some implementations, a JavaScript tag or other code is designated with the purpose of examining and communicating the consumer behaviors of web page consumers to an external server. The JavaScript tag is equipped with a customized pixel or similar signaling software, which is invoked under certain pre-defined conditions associated by any one of the interested entities with the JavaScript Tag and known to all users (e.g. publisher or advertiser) of the JavaScript Tag.

### CROSS REFERENCE TO RELATED APPLICATIONS

The present application claims the benefit of priority under 35 U.S.C. §119(e) of U.S. Provisional Application No. 61/703,223 entitled “Conditional Signaling of Web Page Events Relating to Consumer Attention,” filed on Sep. 19, 2012, by Michael Garrett Seiler and Theodore V. McConnell. The entire contents of the provisional application are incorporated by reference herein.

### BACKGROUND

Web pages, as they render on a browser of a consumer, client, or user (viewer) device, sometimes write data to servers via an IP interface established by a JavaScript program or other similar code, otherwise referred to as a “tag” running in or embedded in the browser. This method for communicating events to other servers or computers has several drawbacks. This method typically requires that the JavaScript program or code can explicitly open a communication channel to a database in a server elsewhere on the internet. In these types of implementations, all users (e.g., advertisers, publishers, or advertisement exchanges in the advertising environment) desirous of the data must gain access to the location to which the data was transmitted to obtain the data for their purpose. Typically, the users do not have access or control of that location. Therefore, this situation typically results in coordination overheads for user entities that require access to the data and format.

As a consequence of these limitations, users (e.g., advertisers, publishers, or advertisement exchanges) cannot easily integrate signals relating to embedded tags that are provided into their own analytics systems.

### SUMMARY

The present invention is directed to a system and methods for communicating parametric independent signals generated in the web pages that are rendered on a browser of a client, consumer, or user (viewer) device. The system and methods overcome the drawbacks of existing systems and techniques. In some implementations, a JavaScript tag enables a user (e.g., a publisher, advertiser, or advertisement exchange etc.) to control the conditions under which a user-provided pixel or signaling software, program, or code is invoked or is triggered. The user (e.g., a publisher, advertiser, or advertisement exchange etc.) may use the conditions created within the JavaScript tag as a general-purpose platform to gain insights by a uniform and publically-provided set of logic. Advantageously, the user (e.g., a publisher, advertiser, or advertisement exchange etc.) of the JavaScript tag does not have to coordinate data processing or communication with the owner of the JavaScript tag to deliver analysis.

In accordance with the present invention, a JavaScript tag is configured as an agent to examine behaviors of web page users (viewers), consumers, or clients and communicate them to an external server. The JavaScript can be equipped, as a parameter to the tag, by its user (e.g., a publisher, advertiser, or advertisement exchange etc.), with a customized pixel to serve as signaling software, program, or code. That pixel, or signaling software, is configured to be invoked by the JavaScript tag (a signal is communicated) only under certain pre-stated or pre-defined conditions endemic to the JavaScript tag and known to all users of the JavaScript tag.

In some implementations, the methods of the present invention, which may be embodied in computer programs or otherwise, comprise a computer-implemented method operated by one or more computing devices, for generating conditional signaling of web page events relating to a consumer (viewer of a advertisement) attention, including one or more operations for 1) providing an agent via a network to a client (consumer, or user (viewer)) device for detecting web page events including consumer or user (viewer) behavior data associated with a particular advertisement on a web page viewed by a consumer or user on the consumer device, wherein the agent determines when a threshold relating to the user (viewer) behavior data has been met and triggers signaling code to transmit the user (viewer) behavior data to a server (e.g., a user-analytics server of a publisher, advertiser, or advertisement exchange) in communication with the agent; 2) receiving the user (viewer) behavior data at the server; and 3) analyzing the user behavior data at the server and using the user (viewer) behavior data for any purpose relating to the particular advertisement, e.g., to optimize performance of the advertisement.

In some implementations, the system of the present invention comprises a processor and memory with instructions for generating conditional signaling of web page events relating to consumer or user (viewer) attention, including 1) providing an agent via a network to a client (consumer, user (viewer)) device for detecting web page events including user (viewer) behavior data associated with a particular advertisement on a web page viewed by a user (viewer) on the client (consumer, user (viewer)) device, wherein the agent determines when a threshold relating to the user (viewer) behavior data has been met and triggers signaling code to transmit the user (viewer) behavior data to a server (e.g., a user-analytics server of a publisher, advertiser, or advertisement exchange) in communication with the agent; 2) receiving the user (viewer) behavior data at the server (e.g., a user-analytics server of a publisher, advertiser, or advertisement exchange); and 3) analyzing the user (viewer) behavior data at the server (e.g., a user-analytics server of a publisher, advertiser, or advertisement exchange) and using the user (viewer) behavior data for any purpose relating to the particular advertisement, e.g., to optimize performance of the advertisement.

### BRIEF DESCRIPTION OF THE DRAWINGS

The present disclosure is illustrated by way of example, and not by way of limitation, in the figures of the accompanying drawings, in which like reference numerals are used to refer to similar elements.

FIG. 1 is a block diagram of example client-server system architecture of the present invention for operating in an advertising environment by providing conditional signaling of web page events relating to consumer (client, or user (viewer)) attention.

FIG. 2A is a block diagram illustrating example hardware components of the client (consumer or user (viewer of an advertisement) device illustrated in FIG. 1.

FIG. 2B is a block diagram illustrating example software components of the first server illustrated in FIG. 1.

FIG. 3 is a flow chart illustrating an example general method for determining whether a certain condition has been met and invoking a pixel or signaling software based on the determination.

FIGS. 4A and 4B is a flow chart illustrating an example method of providing conditional signaling of web page events relating to consumer, client, or user (viewer) attention.

FIG. 5 illustrates a block diagram of a specific example for providing conditional signaling of web page events relating to consumer (viewer of an advertisement) attention from the client (consumer) device to a user-analytics server.

FIG. 6 is a graphic representation illustrating an example data storage configuration with examples of user (viewer) behavior data, switch-set data, and condition data.

### DETAILED DESCRIPTION

In accordance with the present invention, a JavaScript tag is configured and embedded to measure attention by consumers (clients, or users) to advertising during page rendering by their browsers. The JavaScript tag is configured with at least a certain segment of code to accomplish the tasks of: 1) testing whether a pixel or signaling software is present in a particular parameter string (e.g. a URL), 2) testing a “switch” set by the user (e.g., publisher, advertiser, or advertisement exchange) that instructs the JavaScript tag to trigger or “fire” the pixel or signaling software or to not trigger or “fire” the pixel, 3) enabling the section of the code from which the pixel would be invoked if a particular condition is met, the condition for determining if a cursor has been active within a particular advertisement for over a pre-determined threshold of time, 4) in the event the condition is met, the code invoking the pixel as a call to a server (e.g., a user-analytics server (of a publisher, advertiser, advertisement exchange or the like). By this mechanism, a user (e.g., a publisher, advertiser, or advertisement exchange or the like) may control the flow of communication from the JavaScript tag to the destination of the communication and may control the meaning of the signal.

In some implementations, a user (e.g., a publisher, advertiser, or advertisement exchange or the like) may configure or customize a pixel to perform any task a user (e.g., a publisher, advertiser, or advertisement exchange or the like) may desire as a response to conditions under which the pixel is invoked. In some implementations, the user (e.g., a publisher, advertiser, or advertisement exchange or the like) may use the signaling to increment a counter to reflect the number of times a consumer or viewer of an advertisement has browsed through or paid attention to a particular advertisement. That counter may be used to optimize the performance of the advertisement, by analyzing the particular conditions under which consumers have viewed a particular advertisement. For example, information may be compiled on the particular publishers or audience segments that resulted in more viewing attention.

In the following description, for purposes of explanation, numerous specific details are indicated in order to provide a thorough understanding of the technology described. It should be apparent, however, to one skilled in the art, that this technology can be practiced without these specific details. In other instances, structures and devices are shown in block diagram form in order to avoid obscuring the technology. For example, the present technology is described with some embodiments below with reference to user interfaces and particular hardware. However, the present technology applies to any type of computing device that can receive data and commands, and any devices providing services.

Reference in the specification to “one embodiment or implementation,” “an embodiment or implementation,” or “some embodiments or implementations” means simply that one or more particular features, structures, or characteristics described in connection with the one or more embodiments is included in at least one or more embodiments that are described. The appearances of the phrase “in one embodiment or implementation” in various places in the specification are not necessarily all referring to the same embodiment.

Some portions of the detailed descriptions that follow are presented in terms of method algorithms and symbolic representations of operations on data bits within a computer memory of either one or more computing devices typically used in. These algorithmic descriptions and representations are the means used by those skilled in the data processing and arts to most effectively convey the substance of their work to others skilled in the art. An algorithm as indicated here, and generally, is conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the following discussion, it should be appreciated that throughout the description, discussions utilizing terms such as “processing,” “computing,” “calculating,” “determining,” “transmitting,” or “displaying” or the like, refer to the actions and processes of a computer device or system or similar electronic computing device that manipulates and transforms data represented as physical (electronic) quantities within the computer device or system's registers and memories into other data similarly represented as physical quantities within the computer system memories or registers or other such information storage, transmission, or display devices.

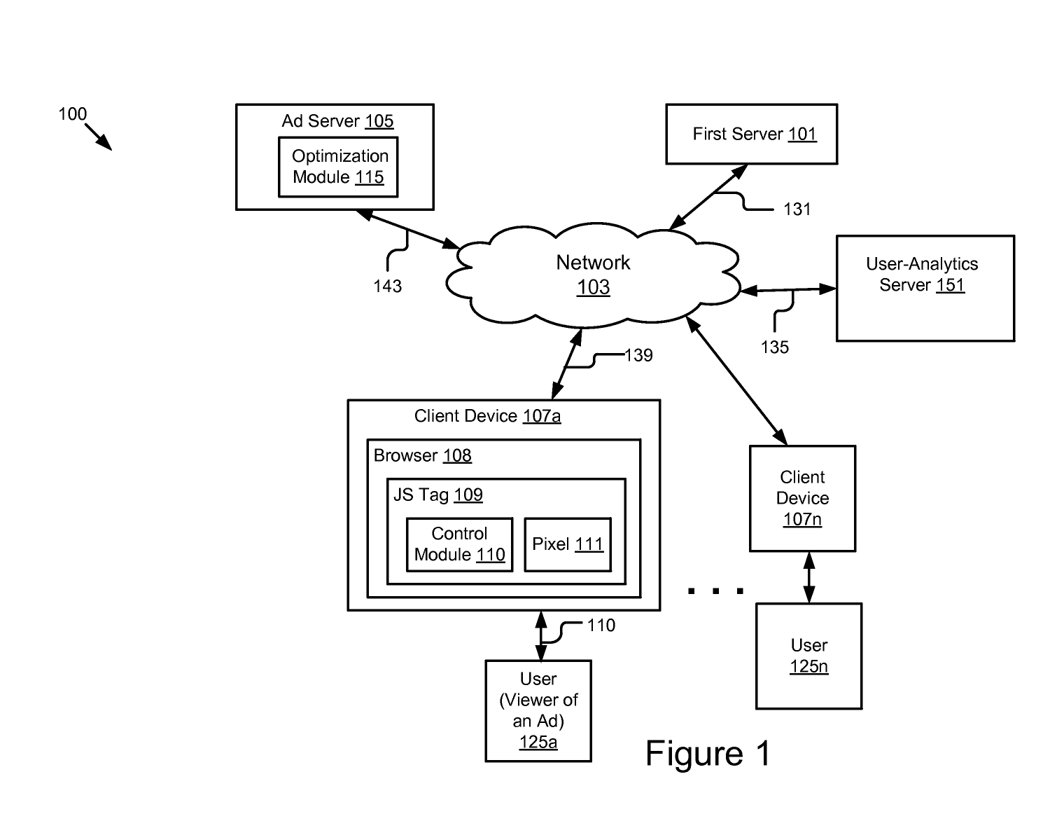

FIG. 1 illustrates a block diagram of example client-server architecture in accordance with the present invention. FIG. 1 illustrates a block diagram of an example advertising system architecture 100 in accordance with the present invention. The advertising system architecture 100 is configured to advantageously collect and present advertising analytics for online delivery of advertising. For many of the examples described in the specification below, an online advertisement (or “ad”) may be any text, picture, or video (with dynamic images), the purpose of which is advertising communication including any flash asset, any image of Internet Advertising Board (IAB) or industry standard width and height that is clickable including any recursion into iframes from the original page. It should be recognized that an advertisement may also include one or more hyperlinks, so that when a particular advertisement is rendered by a client (or consumer or user (viewer)) device, it is possible to select these hyperlinks in order to be redirected to further content provided by an advertiser. A particular advertisement may be encoded by an advertiser as a HyperText Mark-up Language (HTML) file.

The illustrated “ad” system 100 includes an Ad Server 101, a First Server 105, a User-Analytics Server 151 (e.g., of a publisher, advertiser, advertisement exchange or like entity) and one or more client, consumer, or user (viewer) devices 107a-107n that are accessed by users (who are viewers of an advertisement) 125a-125n. In the illustrated embodiment, these entities are communicatively coupled via a network 103. Although only two client devices 107a-n are illustrated, it should be recognized that any number of client devices 107n are available to any number of users 125n. Furthermore, while only one network 103 is coupled to the Ad Server 101, the First Server 105, and the one or more client (or consumer) devices 107a-107n, in practice any number of networks 103 can be connected to the entities.

In one embodiment, the Ad Server 101, the First Server 105, and the User-Analytics Server 151 are hardware servers including a processor, memory, and network communication capabilities. Although only one Ad Server 101, First Server 105, and User-Analytics Server 151 are illustrated, it should be recognized that any number of servers may be coupled via the network 103 for access by the users. In some implementations, the First Server 105 includes an optimization module 115. The First Server 105 may be of any entity interested in either compiling or providing data on consumer attention to web events to other entities (e.g., users including but not limited to a publisher, advertiser, advertisement exchange etc.) interested in acquiring this data for their purpose (e.g., optimization). The User-Analytics Server 151 represents a server for any of these entities to which signaling relating to consumer attention of web events is provided.

The network 103 is a conventional type, wired or wireless, and may have any number of configurations such as a star configuration, token ring configuration or other configurations. Furthermore, the network 103 may comprise a local area network (LAN), a wide area network (WAN) (e.g., the Internet), and/or any other interconnected data path across which multiple devices may communicate. In yet another embodiment, the network 106 may be a peer-to-peer network. The network 106 may also be coupled to or includes portions of a telecommunications network for sending data in a variety of different communication protocols. In yet another embodiment, the network 103 includes Bluetooth communication networks or a cellular communications network for sending and receiving data such as via short messaging service (SMS), multimedia messaging service (MMS), hypertext transfer protocol (HTTP), direct data connection, WAP, email, etc.

The client (or consumer, user, or viewer) device 107a is representative of client devices 107a-107n and is a conventional type of computing device, for example, a personal computer, a hardware server, a laptop computer, a tablet computer, or smart phone. The client devices 107a-107n, are coupled to the network 103, by signal lines 139. In one embodiment, the client device 107 (e.g., 107a) is coupled to receive online advertisements from the Ad Server 101 and other content from publishing sites. The client, consumer, or user (viewer) device 107 (e.g., 107a) includes a web browser 108 for presenting online content and advertisements to the user (e.g., 125a). The web browser 108 presents advertisements and other content, and receives input from the user 125a (e.g. from 125a-125n) as represented by signal line 139. The web browser 108 is configured to provide access to a hosted web page. The web page may comprise a main area in which content is displayed and an advertisement. The browser 108 may include a JS tag 109 comprising a control module 110 and a pixel 111. The JS tag 19 may be provided or embedded in a parametric string (e.g., a URL address) or otherwise as a collection plug-in (applet or the like) operable on the client or consumer device 107 (e.g., 107a).

The Ad Server 101 is a computer program operating on a hardware system for storing and serving advertisements to a particular end user. The Ad Server 101 is coupled to the network 103 by signal line 131 to illustrate receiving advertisements from advertisers. In one embodiment, the Ad Server 101 is also configured to store the advertisements or assets that will be delivered or served to the client devices 107 (a-n) for viewing.

The Ad Server 101 is a computer program operating on a hardware system for placing advertisements on websites. For example, the Ad Server 101 may be a web server that receives advertisements from various entities and delivers them to website visitors. The Ad Server 101 is coupled to the network 103 by signal line 131 for delivering and serving advertisements.

In accordance with one embodiment, a JavaScript (JS) Tag 109 is configured to measure attention by consumers or viewers to particular advertising during page rendering. A segment of code is inserted or placed with the JS Tag 109 to test whether a pixel 111 is present in a particular parameter string (e.g., a URL address). The code is configured to test a “switch” set by the user (e.g., publisher, advertiser, advertisement exchange or like entity) that instructs the JS Tag 109 to either trigger or “fire” the pixel 111 or not. In the event the test yields an affirmative result, the test enables the section of code from which the pixel 111 would be invoked if a particular condition is met. The condition may be a determination if the cursor has been active inside this particular advertisement for over a pre-determined threshold of time. In the event the condition is met, the segment of code may invoke the pixel 111 as a call to a server (for example, the First Server 101). In this way, a user (e.g., publisher, advertiser, advertisement exchange or like entity) can control the flow of communication from the JS Tag 109 to the destination of the communication and controls the meaning of the signal conveyed. The pixel 111 may be configured by the user (e.g., a publisher, advertiser, or advertisement exchange or the like) to address the user's needs, to perform any task that the user (e.g., a publisher, advertiser, or advertisement exchange or the like) may desire or the user may want as a response to the conditions under which the pixel 111 was invoked. In the present embodiment, the user (e.g., a publisher, advertiser, or advertisement exchange or the like) may receive the signal generated at the User-Analytics Server 151 and use the signal generated to increment a counter to reflect the number of times a client, consumer or viewer 125a-125n has given attention to the particular advertisement. The count to indicate the number of viewings of the advertisement may be used later to optimize the performance of the advertisement, by analyzing the conditions under which people gave attention to an advertisement or other purpose. For example, the publishers or the audience segments that resulted in more attention.

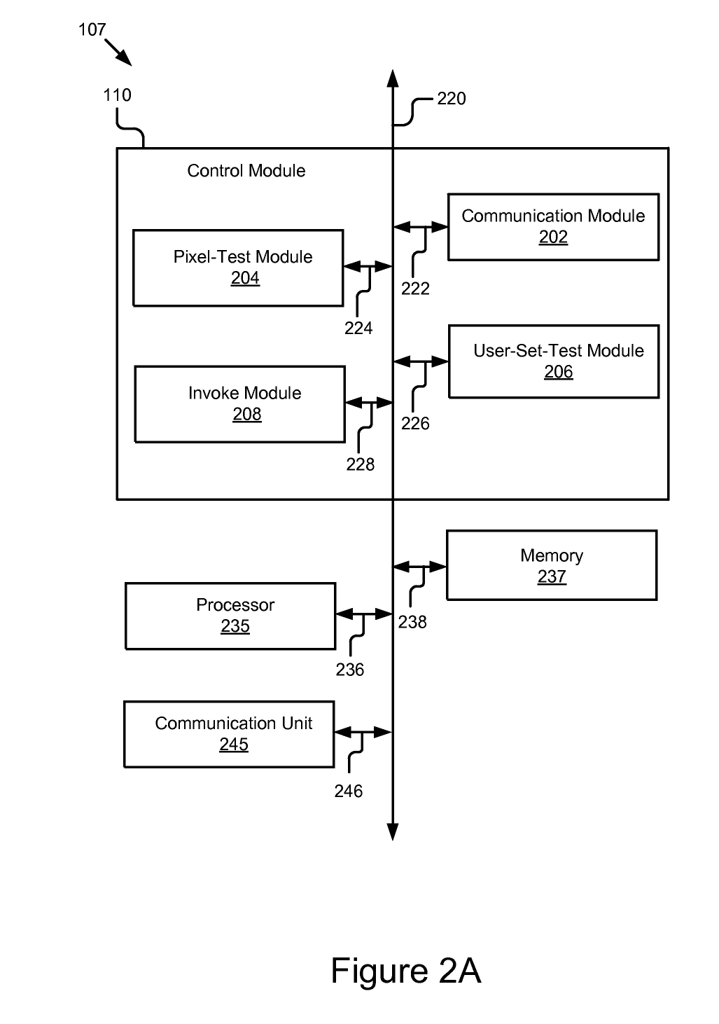

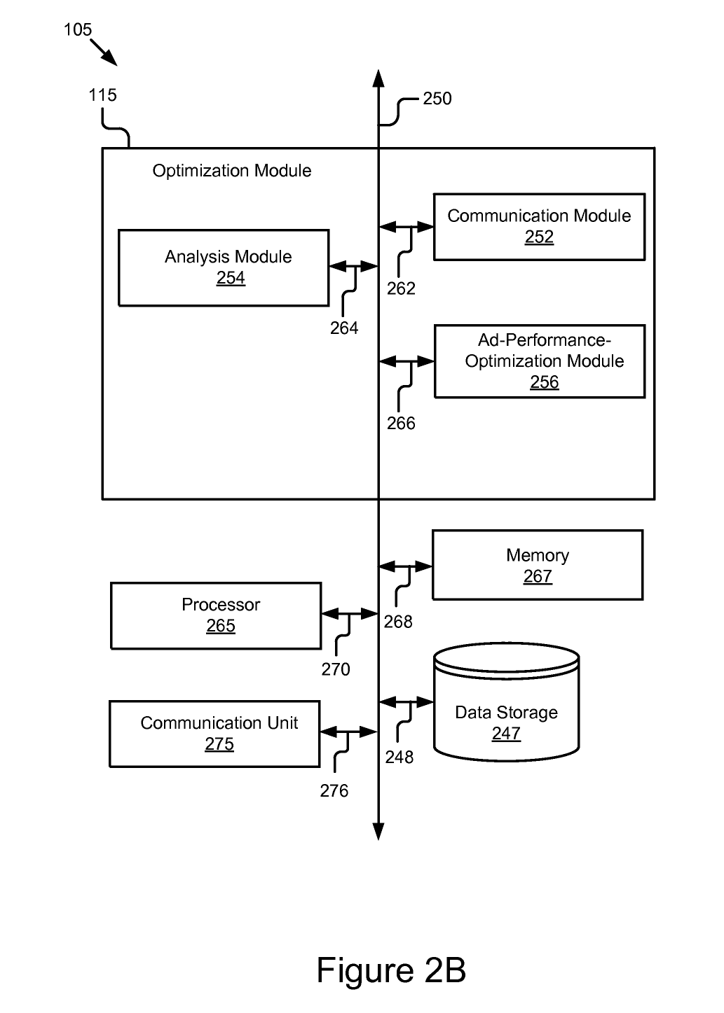

FIG. 2A is a block diagram of one embodiment of the client (consumer or viewer) device 107a. In this embodiment, the client device 107a (or any through 107n) comprises the control module 110, which includes a communication module 202, a pixel-test module 204, a user-set test module 206, and an invoke module 208. The communication module 202 communicates signals to and from the client device 107a. The pixel-test module 204 determines whether a certain pixel should be invoked or triggered and the invoke model 208 invokes or triggers the pixel 111. The user-set test module 206 defines a “switch” set by the user (e.g., a publisher, advertiser, or advertisement exchange or the like). The client, consumer, or viewer device 107a also comprises one or more processors 235, memory 237, a bus 220, a communication unit 245, and data storage 247. The one or more processors 235 comprise an arithmetic logic unit, a microprocessor, a general-purpose controller or some other processor array to perform computations and provide electronic display signals to the client device 107a. The one or more processors 235 are coupled to the bus 220 for communication with the other components. The one or more processors 235 process data signals and may comprise various computing architectures including a complex instruction set computer (CISC) architecture, a reduced instruction set computer (RISC) architecture, or an architecture implementing a combination of instruction sets. Although only a single processor is shown in FIG. 2A, multiple processors may be included as indicated by the indication one or more. Other processors, operating systems, sensors, displays and physical configurations are possible.

The memory 237 stores instructions and/or data that may be executed by the one or more processors 235. The memory 237 is coupled to the bus 220 for communication with the other components. The instructions and/or data may comprise code for performing any and/or all of the techniques described herein. The memory 237 may be a dynamic random access memory (DRAM) device, a static random access memory (SRAM) device, flash memory or some other memory device. In some embodiments, the memory 237 stores the web browser 108.

The communication unit 245 may include a network interface (I/F) module coupled to network 103 by signal line 139 and coupled to the bus 220. The network interface module includes ports for wired connectivity such as but not limited to USB, SD, or CAT-5, etc. The network interface module links the one or more processors 235 to the network 103 that may in turn be coupled to other processing systems. The network interface module provides other connections to the network 103 using standard network protocols such as TCP/IP, HTTP, HTTPS and SMTP. In other embodiments, the network interface module includes a transceiver for sending and receiving signals using Wi-Fi, Bluetooth® or cellular communications for wireless communication. The network interface (I/F) module 208 provides a communication path for the components of the client device 107a (through 107n) to the network 103 and other systems.

Referring now to FIG. 2B, the hardware system of the First Server 105 may comprise one or more processors 265, memory 267, bus 250, communication unit 275 with a network (I/F) module and data storage 247. The one or more processors 265 comprise an arithmetic logic unit, a microprocessor, a general-purpose controller or some other processor array to perform computations and provide electronic display signals for viewing on a client device 107a. The one or more processors 265 are coupled to the bus 220 for communication with the other components. The one or more processors 265 process data signals and may comprise various computing architectures including a complex instruction set computer (CISC) architecture, a reduced instruction set computer (RISC) architecture, or an architecture implementing a combination of instruction sets. Although only a single processor 265 is shown in FIG. 2B, multiple processors may be included as indicated by the indication one or more. Other processors, operating systems, sensors, displays and physical configurations are possible.

The memory 267 stores instructions and/or data that may be executed by the one or more processors 265. The memory 267 is coupled to the bus 250 for communication with the other components. The instructions and/or data may comprise code for performing any and/or all of the techniques described herein. The memory 267 may be a dynamic random access memory (DRAM) device, a static random access memory (SRAM) device, flash memory or some other memory device.

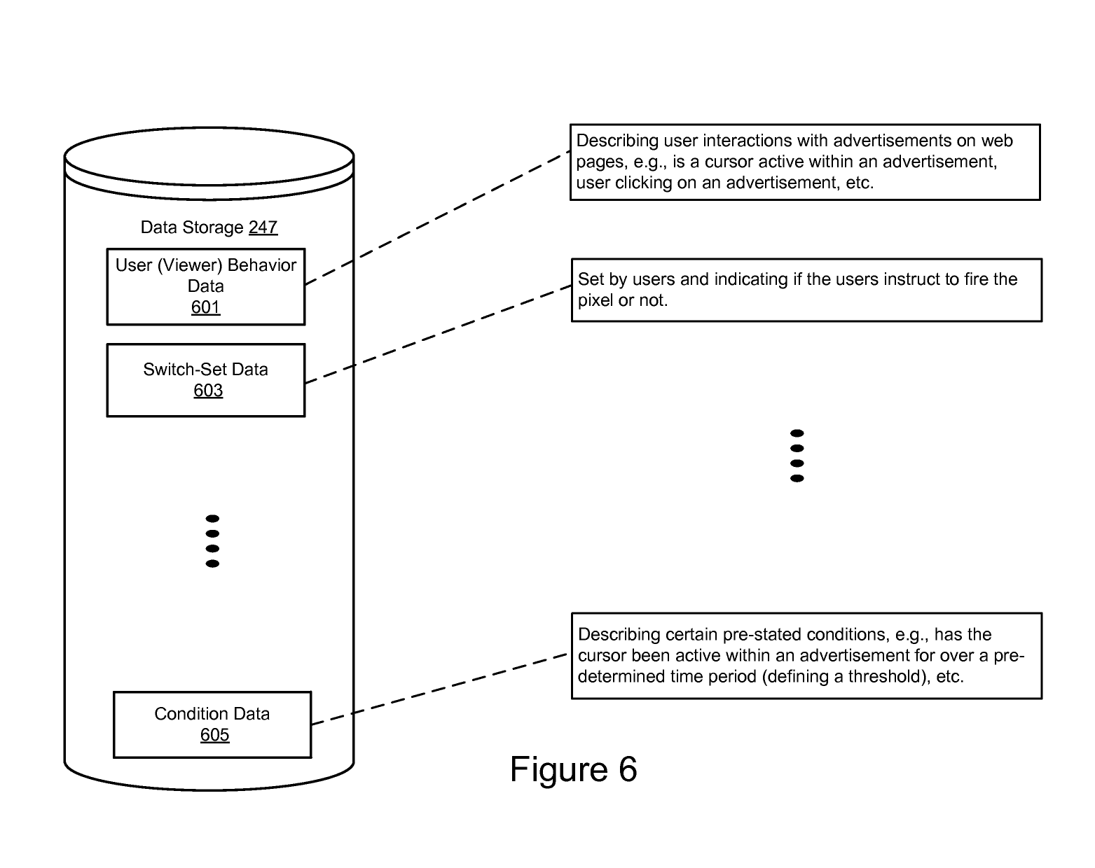

The communication unit 275 including the network interface (I/F) module is coupled to network 103 by signal line 143 and coupled to the bus 250. The communication unit 275 including network interface module includes ports for wired connectivity such as but not limited to USB, SD, or CAT-5, etc. The communication unit 275 links the one or more processors 265 to the network 103 that may in turn be coupled to other processing systems. The communication unit 275 provides other connections to the network 103 using standard network protocols such as TCP/IP, HTTP, HTTPS and SMTP. In other embodiments, the communication unit 275 includes a transceiver for sending and receiving signals using Wi-Fi, Bluetooth® or cellular communications for wireless communication. The communication unit 275 provides a communication path for the components of the First Server 10. The data storage 247 stores any data acquired or obtained from the control module 110 in the client device 107a. Examples of the types of data are described later with reference to FIG. 6. The optimization module 115 includes an analysis module 254 coupled to the bus 250 by signal line 264, a communication module 252 coupled to the bus 250 by signal line 262, and an Ad-Performance Optimization Module 256 coupled to the bus 220 by signal line 266.

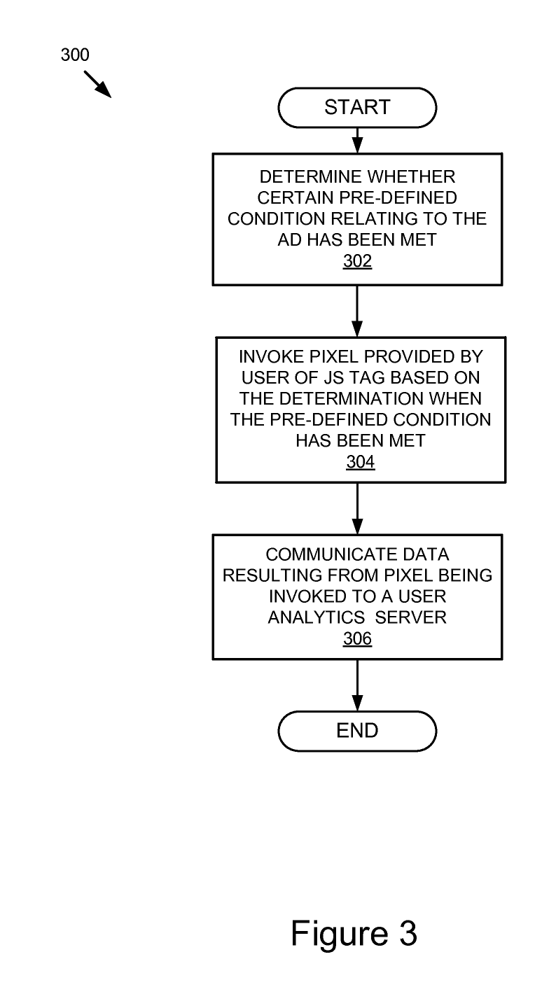

Referring now to FIG. 3, in some implementations, an example general method indicated by reference numeral 300 begins and proceeds to block 302 including one or more operations for determining whether certain pre-defined conditions relating to an advertisement or “ad” (set by a user (e.g., a publisher, advertiser, or advertisement exchange or the like) have been met. It should be recognized that the operations illustrated here are by way of example and that any one or more operations may be either excluded or replaced by other operations that accomplish the same purpose. The method 300 proceeds to the next block 304 including one or more operations for invoking a pixel provided by the user of the JS Tag based on the determination when the pre-defined condition has been met. The method 300 proceeds to the next block 306, which includes one or more operations for communicating data resulting from the pixel being invoked to a server (e.g., a User-Analytics Server 151. From there, the method 300 proceeds to an end that is only to indicate as an end to the routine, program, or set of operations that are set forth in FIG. 3.

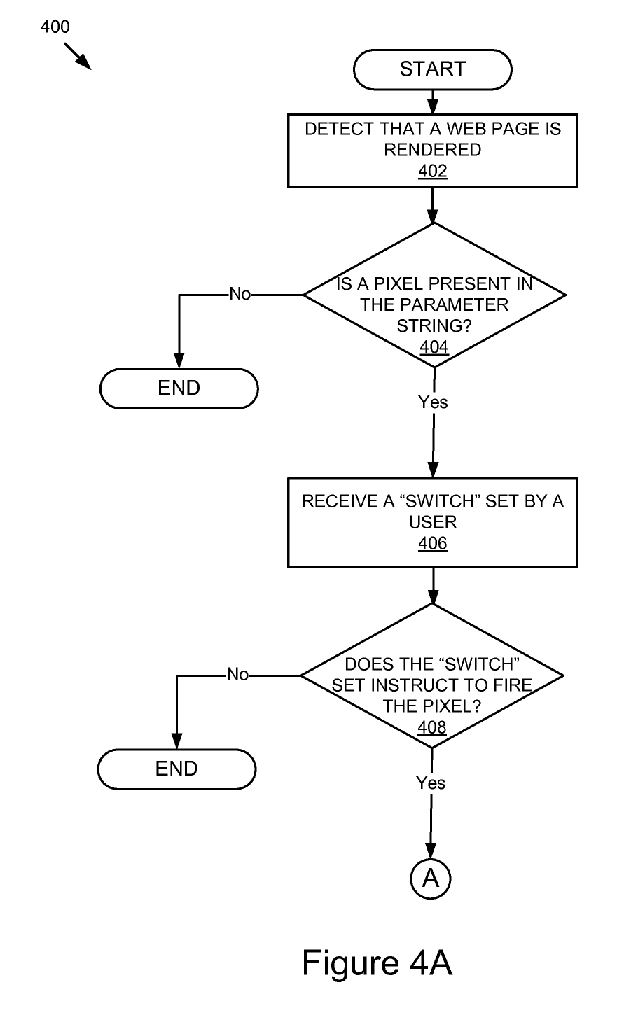

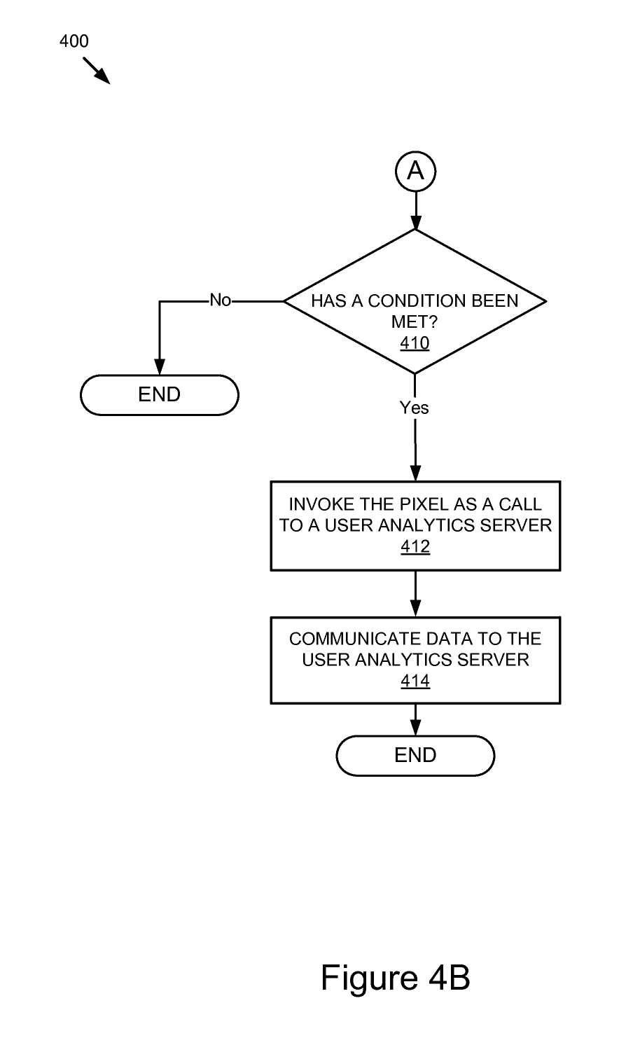

Referring now to FIG. 4A, the method 400 begins and proceeds to block 402 including one or more operations for detecting that a web page (e.g., on a consumer or client device 107a through 17n) is rendered. It should be recognized that the operations illustrated here are by way of example and that any one or more operations may be either excluded or replaced by other operations that accomplish the same purpose. The method 400 proceeds to a decision block 404 including one or more operations for determining if a pixel is present in a particular parameter string (e.g., a URL address) that has been defined. In the event the determination indicates an affirmative (“Yes”) answer, the method 400 proceeds to the next block 406 including one or more operations for receiving a “switch” set by a user (e.g., a publisher, advertiser, or advertisement exchange or the like). In the event the determination indicates a negative (“No”), the method 400 proceeds to an end (to define an end to the set of operations set forth in FIG. 4A). From block 406, the method 400 proceeds to a decision block 408, which includes one or more operations for determining if the “switch” that is set by the user (e.g., a publisher, advertiser, or advertisement exchange or the like) carries an instruction to trigger or “fire” the pixel 111. In the event the answer is negative (“No”), the process 400 ends there. In the event the decision block 408 determines an affirmative (“Yes”), the process proceeds via connector A to operations illustrated in FIG. 4B.

Referring now to FIG. 4B, the method 400 continues and proceeds to a decision block 410, which includes one or more operations for determining if a condition that is defined (e.g., pre-defined or pre-stated by a publisher, advertiser, or advertisement exchange or the like) has been met. In the instance that an answer is negative (“No”), the method 400 concludes. In the instance that the answer is affirmative (“Yes”), the method 400 proceeds to the next block 412, which includes one or more operations to invoke the pixel 111 as a call to a server (e.g. the User-Analytics Server 151 in FIG. 1). The method 400 proceeds to the next block 414, which includes one or more operations for communicating the data compiled at the client or consumer device 107a through 107n to the server (e.g., the User-Analytics Server in FIG. 1). As indicated above, the User-Analytics Server may receive the data for any entity that has embedded or provided the JS Tag (e.g., within the parameter string).

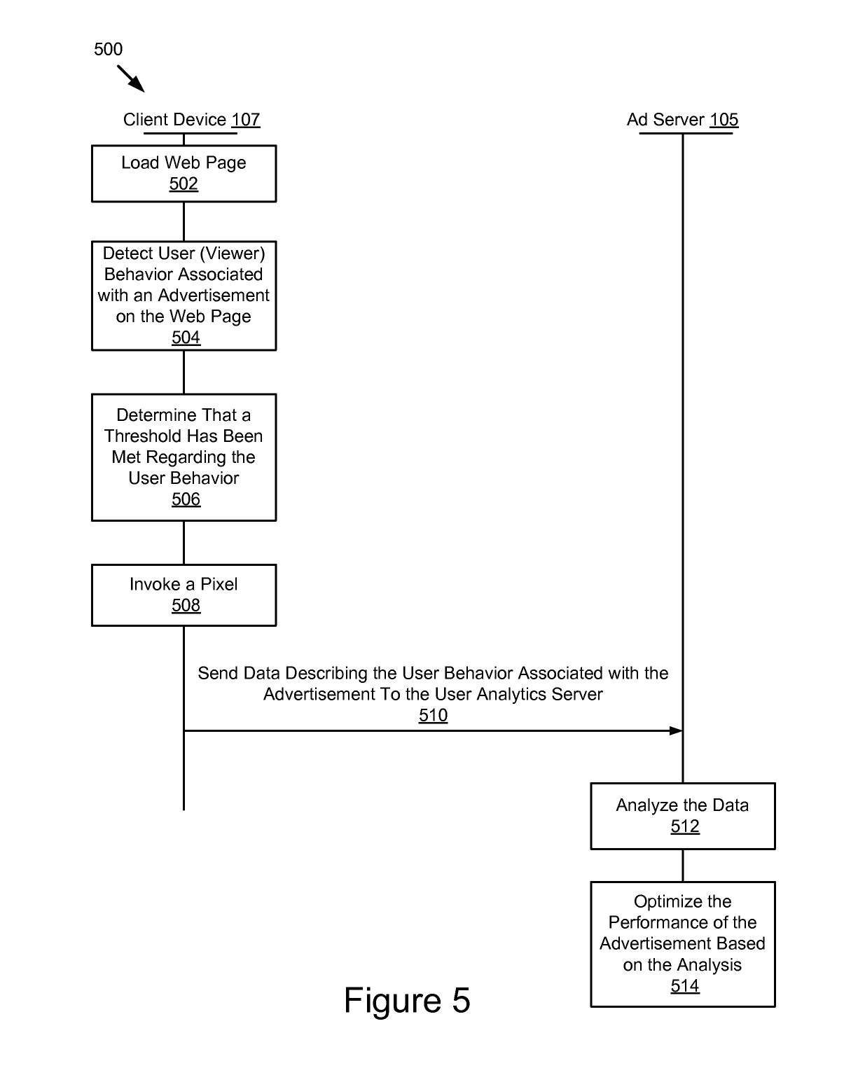

Referring now to FIG. 5, the interchange between the client devices (107a-107n and the First Server 105 is illustrated and indicated generally by reference numeral 500. It should be recognized that the operations illustrated in this figure are by way of example and that any one or more operations may be either excluded or replaced by other operations that accomplish the same purpose. On any of the client or consumer devices 107a through 107n, for use by, for example, consumers or users 125a through 125n, a web page (with particular content including one or more advertisements) may be loaded based upon a request made by the consumers or users 125a through 125n. These operations are indicated generally by block 502. As illustrated by block 504, further operations (one or more) detect consumer or user behavior associated with viewing of any particular advertisement on the web page that is loaded on the client or consumer device (107a through 107n). As further illustrated by block 506, one or more operations are configured to determine that a particular threshold has been met regarding the consumer or user behavior observed or determined. When the threshold has been met, one or more operations are configured to invoke a pixel (e.g., pixel 111). With that indication, data for describing the consumer or user (viewer) behavior associated with the advertisement on the web page is communicated by the First Server to the User-Analytics Server 105 as indicated by reference numeral 510. The First Server 105 also receives the data and may in some implementations analyze the data as illustrated by block 512. The analysis of the data may be used to optimize the performance and effect of the advertisement as illustrated by one or more operations in block 514.

FIG. 6 illustrates the data storage 247 at the First Server 105, including data segments that are compiled at the client or consumer devices 107a through 107n and received at the First Server 105 from the client or consumer devices 107a through 107n. As some examples for illustration purposes, the data segments include user (viewer) behavior data stored as illustrated by block 601, switch-set data as illustrated by block 603, and condition data as illustrated by block 605. The user (viewer) behavior data describes consumer or user (viewer) interactions with advertisements on web pages, e.g., active cursor within an advertisement, user clicking on an advertisement etc. The switch-set data 603 is data that is set by users (viewers) and to indicate user (viewer) instructions to either trigger or “fire” the pixel or to not trigger or “fire” the pixel. The condition data 605 is data that describes certain pre-stated or pre-defined conditions, e.g., has the cursor been active within a particular advertisement for a predetermined threshold of time, etc. These pre-stated or pre-defined conditions are provided by a user in an advertising environment (e.g., a publisher, advertiser, or advertisement exchange or the like)

It should be recognized that the foregoing description of the various embodiments and implementations of the present technology has been presented for the purposes of illustration and description. It is not intended to be exhaustive or to limit the present technology to the precise form disclosed. Many modifications and variations are possible in light of the above teaching. It is intended that the scope of the present technology be limited not by this detailed description, but rather by the claims of this application. As should be understood by those familiar with the art, the present technology may be embodied in other specific forms, without departing from the spirit or essential characteristics thereof. Likewise, the particular naming and division of the blocks, routines, features, attributes, methodologies, and other aspects are not mandatory or significant, and the mechanisms that implement the present disclosure or its features may have different names, divisions and/or formats. Furthermore, as should be apparent to one of ordinary skill in the relevant art, the blocks, routines, features, attributes, methodologies and other aspects of the present technology can be implemented as software, hardware, firmware, or any combination of the three. Also, wherever a component, an example of which is illustrated by a block, of the present technology is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present technology is in no way limited to implementation in any specific programming language, or for any specific operating system or environment. Accordingly, the disclosure of the present technology is intended to be illustrative, but not limiting, of the scope of the present disclosure, which is set forth in the following claims.

1. A computer-implemented method operated by one or more computing devices for generating conditional signaling over a network to indicate web page events relating to consumer attention to a particular advertisement on display on a consumer electronic device during web page rendering, comprising:
configuring a JavaScript tag as an agent and providing the agent by at least one of the one or more computing devices, via a network, to a consumer electronic device, and embedding the agent during web page rendering by a browser in the consumer electronic device, the agent upon being embedded configured for detecting web page events including consumer behavior data associated with a particular advertisement on a particular web page when viewed by a consumer on the consumer device, the particular advertisement on a hosted web page includes text, picture and video data, for viewing by the consumer, and a hyperlink leading to additional information on the particular advertisement and the agent interacting with a pixel provided by user input via the consumer electronic device, and the pixel adapted to perform a task for the user as a response to one or more conditions by which the pixel is invoked, the agent adapted to test if the pixel is present in a particular parameter string associated with the hosted web page, the agent determines when a threshold relating to the consumer behavior data has been met and triggers signaling code including the pixel configured to transmit the consumer behavior data that is compiled to an external server in communication with the agent and the signaling code including the pixel invoked by a user that is at least one of a publisher, advertiser, and an advertising exchange and the agent under predetermined conditions, the pixel adapted to increment a counter to reflect a number of times a viewer of the advertisement browses through the particular advertisement;
receiving by at least one of the one or more computing devices, over the network, the consumer behavior data at an external server; and
analyzing by at least one of the one or more computing devices, the consumer behavior data at the external server and using the consumer behavior data relating to the particular advertisement to optimize performance of the particular advertisement.

2. A computer-implemented method according to claim 1, wherein the particular advertisement includes a plurality of advertisements that are displayed on the hosted web page.

3. The computer-implemented method of claim 2, wherein the advertisements include the text, picture, and video.

4. The computer-implemented method according to claim 2, wherein the plurality of advertisements include one or more hyperlinks leading to more information on the plurality of advertisements.

5. The computer-implemented method of claim 1, wherein the signaling code invoked to determine if the signaling code is present in a particular URL.

6. The computer-implemented method of claim 1, wherein the consumer behavior data includes data to reflect if a cursor is active within the particular advertisement.

7. The computer-implemented method of claim 1, wherein the consumer behavior data includes data to reflect if the consumer has clicked on the particular advertisement.

8. The computer-implemented method of claim 1, wherein the threshold is based on pre-stated conditions including a determination if a cursor on the consumer device is active within the particular advertisement for over a pre-determined time period.

9. A non-transitory computer-program product for generating conditional signaling over a network to indicate web page events relating to consumer attention to a particular advertisement on display on a consumer electronic device during web page rendering, wherein the non-transitory computer-readable program when executed on a computer causes the computer to:
configuring a JavaScript tag as an agent and providing the agent via a network to a consumer electronic device and embedding the agent during page rendering by a browser in the consumer electronic device, wherein the agent once embedded is configured for detecting web page events including consumer behavior data associated with the particular advertisement on a web page when viewed by a consumer on the consumer electronic device, wherein the particular advertisement on a hosted web page includes at least one of text, picture, and video, and a hyperlink leading to additional information on the particular advertisement and wherein the agent interacts with a pixel provided by user input, and wherein the pixel is adapted to perform a task for the user as a response to one or more conditions by which the pixel is invoked, the agent adapted to test if the pixel present in a particular parameter string associated with the hosted web page, the agent determines when a threshold relating to the consumer behavior data has been met and triggers signaling code including the pixel to transmit the consumer behavior data that is compiled to a server in communication with the agent and the signaling code including the pixel invoked by a user that is at least one of a publisher, advertiser, and an advertising exchange and the agent under predetermined conditions, the pixel adapted to increment a counter to reflect a number of times a viewer of the advertisement browses through the particular advertisement;
receive the consumer behavior data at the server; and
analyze the consumer behavior data at the server and using the consumer behavior data relating to the advertisement to optimize performance of the particular advertisement.

10. A non-transitory computer-program product according to claim 9, wherein the particular advertisement includes a plurality of advertisements displayed on the hosted web page.

11. A non-transitory computer-program product according to claim 10, wherein the plurality of advertisements include the text, picture, and video.

12. A non-transitory computer-program product according to claim 10, wherein the plurality of advertisements include one or more hyperlinks leading to more information on the plurality of advertisements.

13. A non-transitory computer-program product according to claim 9, wherein the signaling code is a pixel that is invoked to determine if the signaling code is present in a particular parameter string.

14. A non-transitory computer-program product according to claim 13, wherein the consumer behavior data includes data to reflect if a cursor is active within the particular advertisement.

15. A non-transitory computer-program product according to claim 13, wherein the consumer behavior data includes data to reflect if the consumer has clicked on the particular advertisement.

16. A non-transitory computer-program product according to claim 9, wherein the threshold is based on pre-stated conditions including a determination if a cursor on the consumer device is active within the particular advertisement for over a pre-determined time period.

17. A system for generating conditional signaling over a network to indicate web page events relating to consumer attention to a particular advertisement on display on a consumer electronic device during web page rendering, comprising:
a processor, and;
a memory storing instructions that, when executed, cause the system to:
configuring a JavaScript tag as an agent and providing the agent via a network to a consumer electronic device and embedding the agent during page rendering by a browser in the consumer electronic device, wherein the agent once embedded is configured for detecting web page events including consumer behavior data associated with a particular advertisement on a web page when viewed by a consumer on the consumer device, wherein the particular advertisement on a hosted web page includes at least one of text, picture, and video, and a hyperlink leading to additional information on the particular advertisement and wherein the agent interacts with a pixel provided by user input, and wherein the pixel is adapted to perform a task for the user as a response to one or more conditions by which the pixel is invoked, the agent adapted to test if the pixel is present in a particular parameter string associated with the hosted web page, the agent determines when a threshold relating to the consumer behavior data has been met and triggers signaling code including the pixel configured to transmit the consumer behavior data that is compiled to a server in communication with the agent and the signaling code including the pixel invoked by a user that is at least one of a publisher, advertiser, and an advertising exchange and the agent under predetermined conditions, the pixel adapted to increment a counter to reflect a number of times a viewer of the advertisement browses through the particular advertisement;
receive the consumer behavior data at the server; and
analyze the consumer behavior data at the server and using the consumer behavior data relating to the particular advertisement.

18. A system according to claim 17, wherein the particular advertisement includes a plurality of advertisements that are displayed on the hosted web page.

19. A system according to claim 17, wherein the particular advertisements include text, picture, and video.

20. A system according to claim 17, wherein the plurality of advertisements include one or more hyperlinks leading to more information on the plurality of advertisements.

21. A system according to claim 17, wherein the signaling code is a pixel that is invoked to determine if the signaling code is present in a particular parameter string.

22. A system according to claim 17, wherein the consumer behavior data includes data to reflect if a cursor is active within the particular advertisement.

23. A system according to claim 17, wherein the consumer behavior data includes data to reflect if the consumer has clicked on the particular advertisement.

24. A system according to claim 18, wherein the threshold is based on pre-stated conditions including a determination if a cursor on the consumer device is active within an advertisement for over a pre-determined time period
